(19) United States
(12) Patent Application Publication
(10) Pub. No.: US 2013/0125694 A1
(43) Pub. Date: May 23, 2013

(54) MULTI-AXIS ROBOT

(71) Applicant: Bo LONG, Shenzhen City (CN)

(72) Inventor: Bo LONG, Shenzhen City (CN)

(73) Assignees: HON HAI PRECISION INDUSTRY CO., LTD., Tu-Cheng (TW); HONG FU JIN PRECISION INDUSTRY(ShenZhen) CO., LTD., Shenzhen City (CN)

(21) Appl. No.: 13/550,792

(22) Filed: Jul. 17, 2012

(30) Foreign Application Priority Data
Nov. 18, 2011 (CN) 201110367716.1

(51) Int. Cl. B25J 18/00

(52) U.S. Cl. 74/490.01; 901/27

(57) ABSTRACT

A robot includes a first robot arm, a drive mechanism driving the first robot arm to rotate, a receiving box rotatably connected to the first robot arm. The drive mechanism includes a first drive member and a first speed reducer connected to the first drive member. The first robot arm and the receiving box cooperatively define a first receiving groove, and a first shaft sleeve positioned in the first receiving groove. The first drive member is positioned in the receiving box, and the first speed reducer is positioned in the first receiving groove and movably sleeved on the first shaft sleeve.

### BACKGROUND

1. Technical Field

The present disclosure generally relates to robots, and particularly, to a multi-axis robot used in a spraying room.

2. Description of the Related Art

With the development of machinery industry, a growing number of industrial robots are used in automated production. The robots instead of people operate in harsh environments, such as a spraying room. A robot generally has a plurality of robot arms rotatably connected with each other, and the robot arms transmit power via a plurality of motors and a plurality of electrical wires in order to achieve multi-axis motion. The motors and the electrical wires are generally positioned outside of the robot arms. However, during spraying operation in the spraying room, the motors and the electrical wires are exposed in the spraying room, allowing the motors and electrical wires to be contaminated with paint. Furthermore, dust from the motors and the electrical wires may be fallen on the workpiece to be painted, causing the workpiece to have an ugly appearance. Moreover, the motors are easily contaminated by organic solvent in the spraying room, which may lead to an explosion in the spraying room.

Therefore, there is room for improvement within the art.

### BRIEF DESCRIPTION OF THE DRAWING

The components in the drawings are not necessarily drawn to scale, the emphasis instead placed upon clearly illustrating the principles of the present disclosure. Moreover, in the drawings, like reference numerals designate corresponding parts throughout the several views.

FIG. 1 is an isometric, assembled view of an embodiment of a robot.

FIG. 2 is an isometric, exploded view of the robot of FIG. 1.

FIG. 3 is a partial, side cross-sectional view of the robot of FIG. 1, taken along the line

FIG. 4 is a partial, side cross-sectional view of the robot of FIG. 1, taken along the line IV-IV.

### DETAILED DESCRIPTION

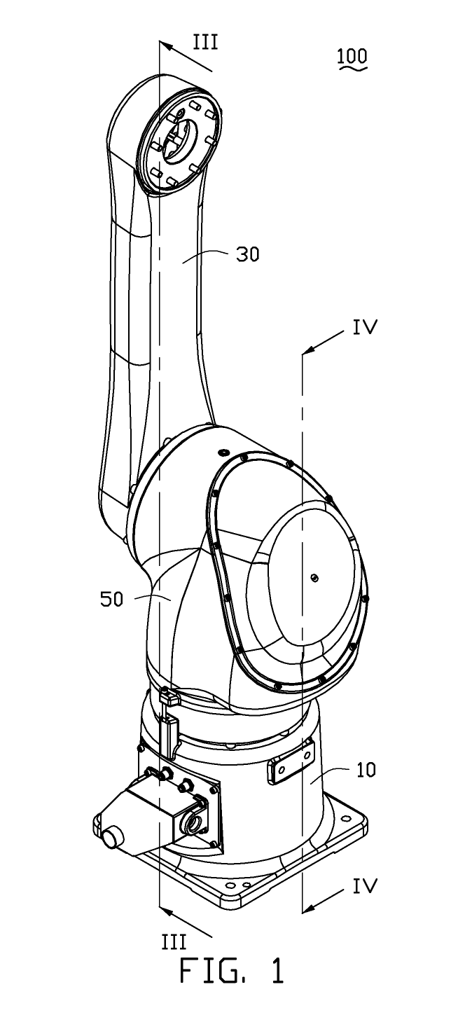

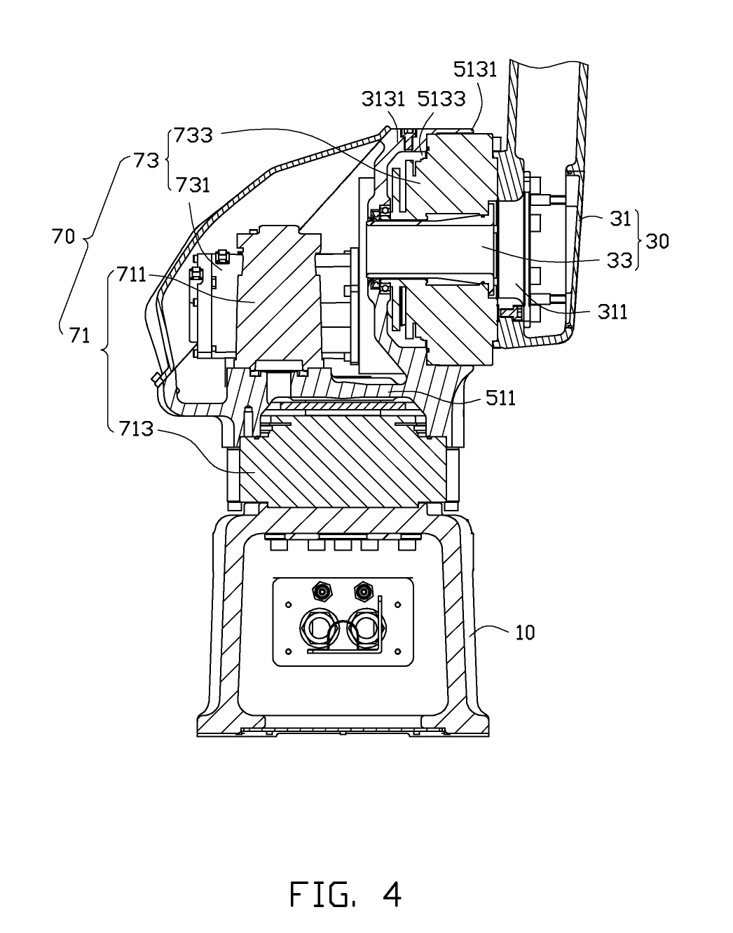

FIGS. 1 and 4, illustrate an embodiment of a robot 100. The robot 100 includes a first robot arm 10, a second robot arm 30, a receiving box 50, and a drive mechanism 70. The first robot arm 10 and the second robot arm 30 are rotatably connected to the receiving box 50, respectively. A rotating axis of the first robot arm 10 is substantially perpendicular to a rotating axis of the second robot arm 30. The drive mechanism 70 is received in the first robot arm 10, the second robot arm 30, and the receiving box 50, in order to drive the first robot arm 10 and the second robot arm 30 to rotate relative to the receiving box 50.

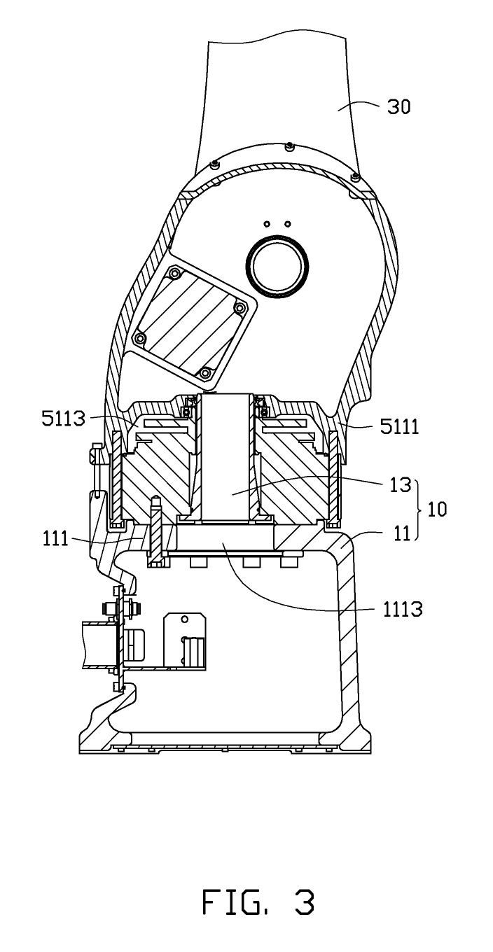

Referring to FIG. 3, the first robot arm 10 includes a base 11 and a first shaft sleeve 13. The base 11 is substantially hollow cylindrical, and a mounting portion 111 is formed at an end of the base 11 for mounting the receiving box 50. A center of the mounting portion 111 defines a through hole 1113 communicating with the first shaft sleeve 13. The first shaft sleeve 13 is substantially hollow cylindrical. The first shaft sleeve 13 is aligned with the through hole 1113. A plurality of wires and pipes (not shown), such as a paint transmitting pipe, a signal transmitting wire, a gas pipe, and an electrical wire, extend through the first shaft sleeve 13.

The second robot arm 30 includes a main portion 31 and a second shaft sleeve 33. An end of the main portion 31 adjacent to the second shaft sleeve 33 defines a connecting hole 311 communicating with the second shaft sleeve 33. The second shaft sleeve 33 is aligned with the connecting hole 311 of the main portion 31. The second shaft sleeve 33 is substantially perpendicularly to the first shaft sleeve 13, thereby allowing the wires and pipes to extend through the first shaft sleeve 13 and the second shaft sleeve 33 from the first robot arm 10, and then enter into the second robot arm 30.

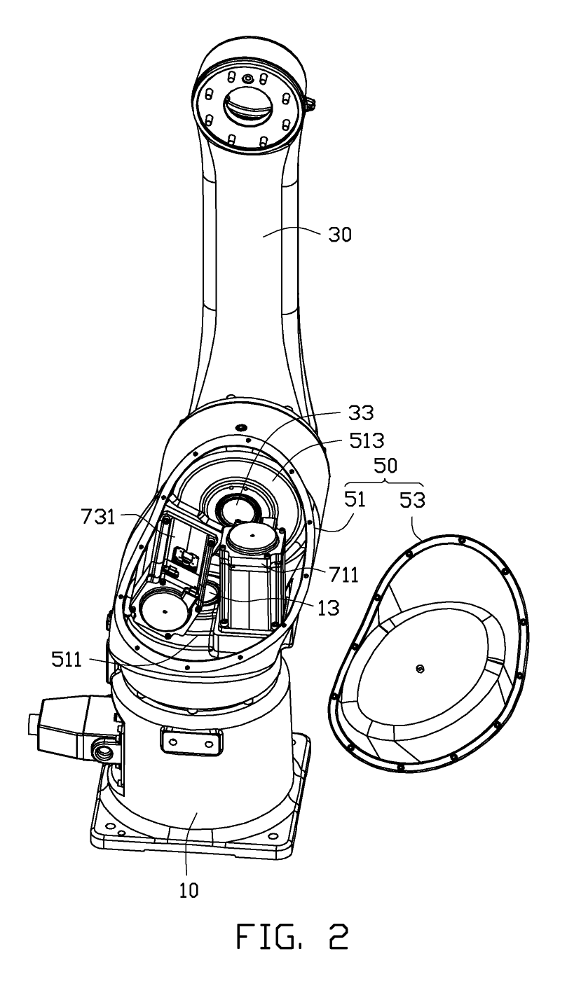

Referring to FIG. 2, the receiving box 50 is made by casting, and includes a housing 51 and a cover 53 fixed to the housing 51. The housing 51 includes a first assembly portion 511 and a second assembly portion 513 substantially perpendicular to the first assembly portion 511. The first assembly portion 511 is fixed to the first robot arm 10, and a first connecting end 5111 is formed on the first assembly portion 511 towards the first robot arm 10. The first connecting end 5111 is positioned above the mounting portion 111, and thus the first connecting end 5111 and the mounting portion 111 cooperatively define a first receiving groove 5113 for receiving the drive mechanism 70 and the first shaft sleeve 13. A center of the first assembly portion 511 defines a positioning hole (not labeled) for positioning and exposing the first shaft sleeve 13. The second assembly portion 513 is positioned on the second robot arm 30, and a second connecting end 5131 is formed on the second assembly portion 513 towards the second robot arm 30. The second connecting end 5131 is positioned on the main portion 31, and thus the second connecting end 5131 and the main portion 31 cooperatively define a second receiving groove 5133 for receiving the drive mechanism 70 and the second shaft sleeve 33. A center of the second assembly portion 513 defines a positioning hole (not labeled) for positioning and exposing the second shaft sleeve 33.

The drive mechanism 70 includes a first drive assembly 71 and a second drive assembly 73. The first drive assembly 71 includes a first drive member 711 and a first speed reducer 713. The first drive member 711 is fixed to first assembly portion 511 of the receiving box 50, and configured to drive the first speed reducer 713. The first speed reducer 713 is positioned in the first receiving groove 5113, and movably sleeved on the first shaft sleeve 13 of the first robot arm 10. The first speed reducer 713 is connected to the first drive member 711, such that the first drive member 711 can drive the first speed reducer 713 to rotate. As a result, the receiving box 50 is rotated relative to the first robot arm 10.

The second drive assembly 73 includes a second drive member 731 and a second speed reducer 733. The second drive member 731 is fixed to second assembly portion 513 of the receiving box 50, and configured to drive the second speed reducer 733. The second speed reducer 733 is positioned in the second receiving groove 5133, and movably sleeved on the second shaft sleeve 33 of the second robot arm 30. The second speed reducer 733 is connected to second drive member 731, such that the second drive member 731 can drive the second speed reducer 733 to rotate. As a result, the second robot arm 30 is rotated relative to the receiving box 50.

Both the first drive member 711 and the second drive member 731 are received in the receiving box 50. The wires and the pipes extend through the first shaft sleeve 13, the receiving box 50, and the second shaft sleeve 33; therefore, the first drive member 711, the second drive member 731, the wires, and the pipes can avoid exposure to outside environment, such as a spraying room. As a result, the first drive member 711, the second drive member 731, the wires, and the pipes will not get contaminated by spray painting, thereby allowing easy clean up in the spraying room. In an alternative embodiment, the second robot arm 30 and the second drive assembly 73 may be omitted in the robot 100.

While the present disclosure has been described with reference to particular embodiments, the description is illustrative of the disclosure and is not to be construed as limiting the disclosure. Therefore, various modifications can be made to the embodiments by those of ordinary skill in the art without departing from the true spirit and scope of the disclosure, as defined by the appended claims.

What is claimed is:

1. A robot, comprising:
a first robot arm;
a drive mechanism driving the first robot arm to rotate, the drive mechanism comprising a first drive member and a first speed reducer connected to the first drive member; and
a receiving box rotatably connected to the first robot arm;
wherein the first robot arm and the receiving box cooperatively define a first receiving groove, and a first shaft sleeve positioned in the first receiving groove; the first drive member is positioned in the receiving box, the first speed reducer is positioned in the first receiving groove and movably sleeved on the first shaft sleeve.

2. The robot of claim 1, further comprising a second robot arm rotatably connected to the receiving box, wherein the second robot arm and the receiving box cooperatively define a second receiving groove; the second robot arm comprises a second shaft sleeve positioned in the second receiving groove; the drive mechanism further comprises a second drive member and a second speed reducer connected to the second drive member, the second speed reducer is positioned in the second receiving groove and movably sleeved on the second shaft sleeve.

3. The robot of claim 1, wherein the first robot arm further comprises a base, an end of the base forms a mounting portion for positioning the receiving box; a center of the mounting portion defines a through hole communicating with the first shaft sleeve.

4. The robot of claim 3, wherein the receiving box comprise a housing having a first assembly portion, and the first assembly portion has a first connecting end towards the first robot arm; the first connecting end is positioned above the mounting portion to cooperatively define the first receiving groove.

5. The robot of claim 4, wherein a center of the first assembly portion defines a positioning hole for positioning and exposing the first shaft sleeve.

6. The robot of claim 4, wherein the second robot arm further comprises a main portion, an end of the main portion adjacent to the second shaft sleeve defines a connecting hole communicating with the second shaft sleeve.

7. The robot of claim 3, wherein the receiving box further comprises a second assembly portion substantially perpendicular to the first assembly portion, and a second connecting end is formed on the second assembly portion towards the second robot arm; the second connecting end is positioned on the main portion to cooperatively define the second receiving groove.

8. The robot of claim 7, wherein a center of the second assembly portion defines a positioning hole for positioning and exposing the second shaft sleeve.

9. The robot of claim 4, wherein the receiving box further comprises a cover fixed to the housing.

10. A robot, comprising:
a first robot arm;
a drive mechanism driving the first robot arm to rotate; and
a receiving box rotatably connected to the first robot arm;
wherein the receiving box comprises a housing, the housing has a first assembly portion and a second assembly portion substantially perpendicular to the first assembly portion; a first shaft sleeve is positioned in the first assembly portion, and a second shaft sleeve is positioned in the second assembly portion.

11. The robot of claim 10, wherein the drive mechanism comprises a first drive member and a first speed reducer connected to the first drive member.

12. The robot of claim 11, further comprising a second robot arm rotatably connected to the receiving box, wherein the second robot arm and the receiving box cooperatively define a second receiving groove; the second shaft sleeve positioned in the second receiving groove; the drive mechanism further comprises a second drive member and a second speed reducer connected to the second drive member, the second speed reducer is positioned in the second receiving groove and movably sleeved on the second shaft sleeve.

13. The robot of claim 11, wherein the first robot arm further comprises a base, an end of the base forms a mounting portion for positioning the receiving box; a center of the mounting portion defines a through hole communicating with the first shaft sleeve.

14. The robot of claim 13, wherein the first assembly portion has a first connecting end towards the first robot arm, and the first connecting end is positioned above the mounting portion to cooperatively define a first receiving groove.

15. The robot of claim 14, wherein a center of the first assembly portion defines a positioning hole for positioning and exposing the first shaft sleeve.

16. The robot of claim 14, wherein the second robot arm further comprises a main portion, an end of the main portion adjacent to the second shaft sleeve defines a connecting hole communicating with the second shaft sleeve.

17. The robot of claim 16, wherein a second connecting end is formed on the second assembly portion towards the second robot arm; the second connecting end is positioned on the main portion to cooperatively define the second receiving groove.

18. The robot of claim 17, wherein a center of the second assembly portion defines a positioning hole for positioning and exposing the second shaft sleeve.
